(19) United States
(12) Patent Application Publication
(10) Pub. No.: US 2008/0077766 A1
(43) Pub. Date: Mar. 27, 2008

(54) INFORMATION PROCESSING APPARATUS AND INFORMATION PROCESSING METHOD

(75) Inventor: Yoshinori Kohmoto, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 11/839,803

(22) Filed: Aug. 16, 2007

(30) Foreign Application Priority Data
Sep. 27, 2006 (JP) 2006-263043

(51) Int. Cl. G06F 12/08

(52) U.S. Cl. 711/205; 711/E12.059

(57) ABSTRACT

According to one embodiment, an information processing apparatus includes a system memory and a video memory allocated to a part of a storage area of the system memory. A storing unit stores a plurality of tables each corresponding to one of a plurality of kinds of operating systems and storing a combination of a capacity of the system memory and a capacity of the video memory. An identifying unit identifies an installed operating system. A selecting unit selects, from the tables stored in the storing unit, a table corresponding to the installed operating system identified by the identifying unit. A detecting unit detects the capacity of the system memory. A setting unit sets the capacity of the video memory in accordance with the capacity of the system memory detected by the detecting unit and the table selected by the selecting unit.

### CROSS-REFERENCE TO RELATED APPLICATIONS

This application is based upon and claims the benefit of priority from Japanese Patent Application No. 2006-263043, filed Sep. 27, 2006, the entire contents of which are incorporated herein by reference.

### BACKGROUND

1. Field

One embodiment of the invention relates to an information processing apparatus and an information processing method that can control memory setting.

2. Description of the Related Art

Conventionally, various techniques have been proposed which change memory setting of an information processing apparatus in accordance with an operation environment. For example, Japanese Patent Application KOKAI Publication No. 2002-140229 proposes a technique of generating, in response to a booting event, a configuration table which represents hardware resources of a system including a physical memory of the system. Then, the configuration table is modified such that only a part of the physical memory is identified, thereby reserving the other part of the physical memory, and preventing the reserved part from being controlled by an operating system (OS).

Additionally, Japanese Patent Application KOKAI Publication No. 9-293016 proposes a decoding circuit including: a setting switch which sets a memory usage in accordance with the kind of a memory; and a decoder which decodes a signal output from the setting switch and a control bus and an address bus of a CPU. Various kinds of available memory capacities can be changed depending on the setting of the setting switch.

A plurality of kinds of OSs may be installed in an information processing apparatus. For example, a user may purchase a personal computer on which an OS is installed, and may install another OS on the personal computer after purchasing. In addition, during a transitional period from one OS to another OS, manufacturers of information processing apparatuses may support two kinds of OSs. In such a case, memory setting may be different between the two kinds of OSs. Generally, the memory capacity is set by a BIOS (Basic Input/Output System). Hence, in the case where the memory setting and the like are different between OSs, a BIOS is prepared for each of the OSs. However, development process may be increased and maintenance/management may become complicated by preparing a BIOS for each OS.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view of an information processing apparatus according to an embodiment of the invention;

FIG. 2 is an exemplary block diagram showing an exemplary system configuration of the information processing apparatus shown in FIG. 1;

FIG. 3 is an exemplary flowchart for explaining an information processing method according to an embodiment of the invention;

FIG. 4 is an exemplary flowchart for explaining a method of setting video memory;

FIG. 5A is an exemplary table showing an example of a table A which stores memory setting information corresponding to an OS#1;

FIG. 5B is an exemplary table showing an example of a table B which stores memory setting information corresponding to an OS#2; and

FIG. 6 is an exemplary flowchart for explaining a method of automatically changing video memory setting.

### DETAILED DESCRIPTION

Various embodiments according to the invention will be described hereinafter with reference to the accompanying drawings. In general, according to one embodiment of the invention, an information processing apparatus includes: a system memory; a video memory allocated to a part of a storage area of the system memory; a storing unit which stores a plurality of tables each corresponding to one of a plurality of kinds of operating systems and storing a combination of a capacity of the system memory and a capacity of the video memory; an identifying unit which identifies an installed operating system; a selecting unit which selects, from the tables stored in the storing unit, a table corresponding to the installed operating system identified by the identifying unit; a detecting unit which detects the capacity of the system memory; and a setting unit which sets the capacity of the video memory in accordance with the capacity of the system memory detected by the detecting unit and the table selected by the selecting unit.

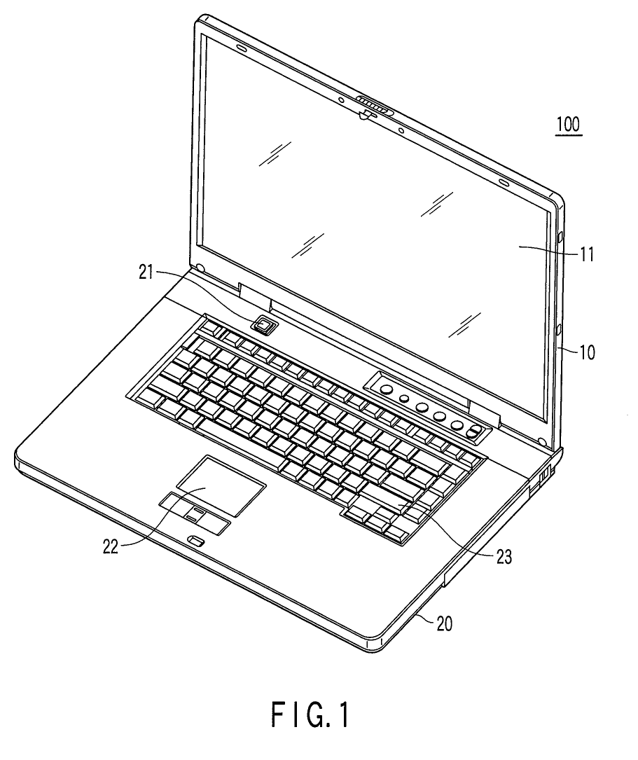

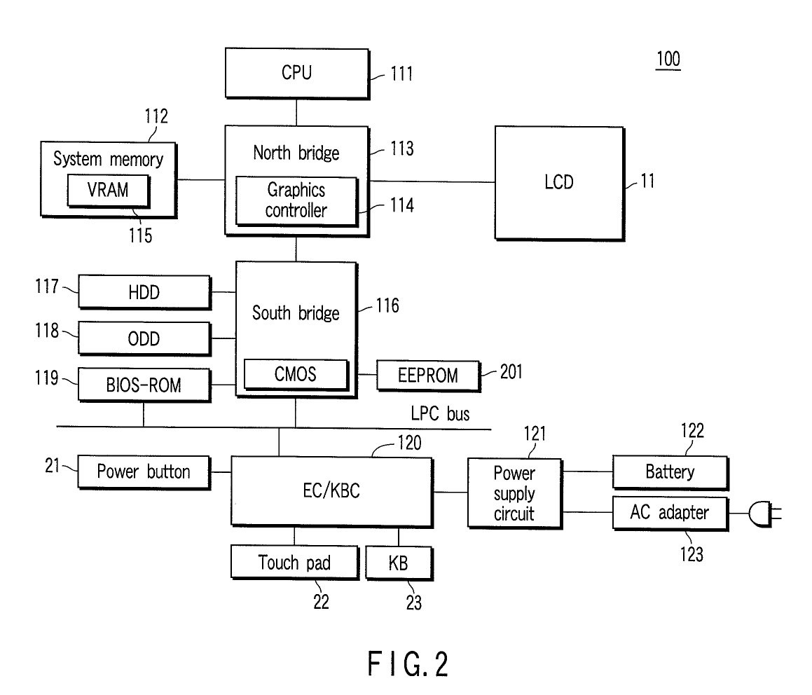

Referring to FIGS. 1 and 2, a description is given of an information processing apparatus according to an embodiment of the invention. The information processing apparatus is realized by, for example, a notebook portable personal computer (hereinafter simply referred to as “the personal computer”) 100.

FIG. 1 is an exemplary perspective view of the personal computer 100 in a state where a display unit 10 is opened. The personal computer 100 includes the display unit 10 and a main body 20. The display unit 10 is provided with a display portion 11, which is formed by a liquid crystal display (LCD). The main body 20 includes a box-shaped housing, and the housing includes a power button 21, a touch pad 22, a keyboard 23, etc. The display unit 10 is connected to the main body 20 such that the display unit 10 can be rotated with respect to the main body 20 in a certain angular range.

FIG. 2 is an exemplary block diagram showing an exemplary system configuration of the personal computer 100.

As shown in FIG. 2, the personal computer 100 includes the power button 21, the touch pad 22, the keyboard (KB) 23, the display portion (LCD) 11, a CPU 111, a system memory 112, a north bridge 113, a graphics controller 114, a video memory (VRAM) 115, a south bridge 116, a hard disk drive (HDD) 117, an optical disk drive (ODD) 118, a BIOS-ROM 119, an embedded controller/keyboard controller IC (EC/KBC) 120, a power supply circuit 121, a battery 122, an AC adapter 123, an EEPROM 201, etc.

The CPU 111 is a processor which controls an operation of the personal computer 100. The CPU 111 executes an operating system (OS) and various kinds of application programs which are loaded from the hard disk drive (HDD) 117 to the system memory 112.

Additionally, the CPU 111 also executes a BIOS (Basic Input/Output System) stored in the BIOS-ROM 119. The BIOS-ROM 119 is a non-volatile memory such as a flash EEPROM. The BIOS is a program for hardware control, and is initially executed when the personal computer 100 is turned ON. In an embodiment of the invention, when the personal computer 100 is turned ON, the BIOS identifies the OS installed on the personal computer 100. In accordance with the identified result, the BIOS selects one of a plurality of video memory setting tables. A video memory setting table is prepared in advance for each of a plurality of kinds of OSs which may be installed on the personal computer 100. The video memory setting table stores, for example, a combination of: a capacity of the system memory; a default capacity of the video memory corresponding to the capacity of the system memory; and one or more selectable (available) capacities of the video memory. The OS is booted after the video memory capacity is set in accordance with the capacity of the system memory 112 and a selected video memory setting table.

The north bridge 113 is a bridge device connecting a local bus of the CPU 111 to the south bridge 116. The north bridge 113 includes a memory controller which performs access control of the system memory 112. Additionally, the north bridge 113 incorporates therein the graphics controller 114.

The graphics controller 114 is a display controller controlling the LCD 11 which is used as a display-monitor of the personal computer 100. The graphics controller 114 outputs, to the LCD 11, an image signal corresponding to display data which are written to the VRAM 115 by the OS or the application programs. It should be noted that a part of storage area of the system memory 112 is allocated to the VRAM 115.

The south bridge 116 controls each device on an LPC (Low Pin Count) bus. Additionally, the south bridge 116 incorporates therein an IDE (Integrated Drive Electronics) controller for controlling the HDD 117 and the ODD 118. Further, the south bridge 116 incorporates therein a CMOS memory. The EEPROM 201 is connected to the south bridge 116 via, for example, an SM (System Management) bus.

The HDD 117 is a storage device storing data and various kinds of software. The ODD 118 is a drive unit which drives a DVD storing video contents such as DVD titles, a CD storing music data, etc.

The embedded controller/keyboard controller IC (EC/KBC) 120 is a one-chip microcomputer where an embedded controller (EC) for power management and a keyboard controller (KBC) for controlling the touch pad 22 and the keyboard 23 are integrated. Irrespective of whether or not the personal computer 100 is turned ON, the EC/KBC 120 is always turned ON by power from the power supply circuit 121. The EC/KBC 120 performs a process of turning ON/OFF the personal computer 100 in combination with the power supply circuit 121, in response to an operation of the power button 21 by a user.

The power supply circuit 121 generates power to be supplied to each component in the personal computer 100 by using power from the battery 122 incorporated in the personal computer 100 or by using power externally supplied via the AC adapter 123.

According to the above-mentioned personal computer 100, it is possible to provide an information processing apparatus which can flexibly and easily perform video memory setting for each of a plurality of kinds of OSs. Additionally, even in the case where a plurality of kinds of video memory settings are used in a single information processing apparatus, it is unnecessary to prepare as many BIOSs as the plurality of kinds of video memory settings. That is, it is possible to handle a plurality of kinds of OSs by using a single BIOS. Accordingly, it is possible to reduce development processes and development resources, and to simplify maintenance/management.

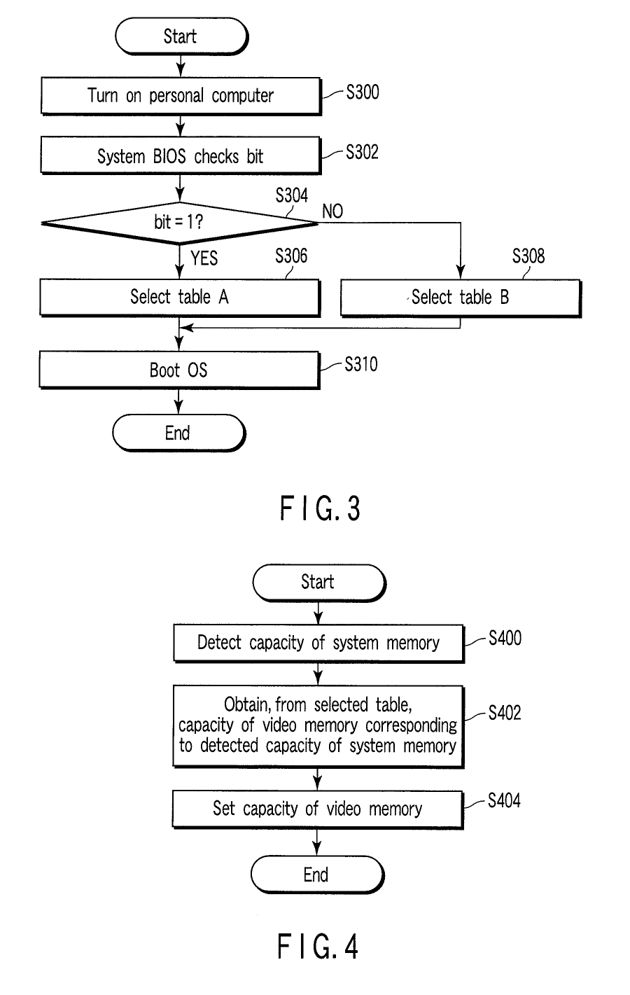

Referring to an exemplary flowchart of FIG. 3, a description is given of an information processing method according to an embodiment of the invention. The information processing method can be applied to the personal computer 100 shown in FIG. 1. Hereinafter, a description is given of a case where the information processing method according to this embodiment is applied to the personal computer 100. The flowchart of FIG. 3 shows an exemplary case where the personal computer 100 supports two kinds of OSs (OS#1 and OS#2) requiring different video memory settings. For example, the personal computer 100 can support two kinds of OSs, Windows XP (registered trademark) and Windows Vista (registered trademark).

The user presses down the power button 21 so as to turn ON the personal computer 100 (block S300). The system BIOS checks a bit for identifying an OS, which bit is set to the personal computer 100 (block S302). By checking the bit, it is possible to identify the OS installed on the personal computer 100. For example, a bit “1” may be allocated to the OS#1, and a bit “0” may be allocated to the OS#2. Various methods may be used for setting the bit. For example, the bit may be set to a non-volatile memory of the personal computer 100. The BIOS-ROM 119 or the EEPROM 201 connected to the south bridge 116 may be used as the non-volatile memory. In addition, the bit may be set to the CMOS memory incorporated in the south bridge 116. Since the CMOS memory is a memory backed up by its own power supply, the CMOS memory may be considered as one of non-volatile memories. Further, a hardware ID may be set to a motherboard (not shown) of the personal computer 100. Hereinafter, a description is given of an exemplary case where the bit (identification information) for identifying the OS is set to the EEPROM 201.

In block S304, it is determined whether or not the bit set to the EEPROM 201 is equal to 1. In the case where the bit is “1”, i.e., in the case where the OS#1 is installed on the personal computer 100 (YES in block S304), the BIOS selects a table A storing memory setting information corresponding to the OS#1 (block S306). On the other hand, in the case where the bit is “0”, i.e., in the case where the OS#2 is installed on the personal computer 100 (NO in block S304), the BIOS selects a table B storing memory setting information corresponding to the OS#2 (block S308).

Here, a brief description is given of a reason why a different video memory setting table is used for each OS. Generally, an OS requires hardware to satisfy certain specifications. For example, in the case where the system memory capacity is 512 MB, the OS#1 may allow allocation of the video memory capacity up to 128 MB. On the other hand, the OS#2 may require 448 MB for the minimum system memory capacity. Hence, in the case where the system memory capacity is 512 MB, it is impossible to allocate 128 MB to the video memory capacity, and the video memory capacity is limited to 64 MB. Accordingly, a different video memory setting table is prepared for each OS. A detailed description of the tables A and B will be given later.

After the table A or B is selected (block S306 or S308), the OS (OS#1 or OS#2) installed on the personal computer 100 is booted (block S310). In other words, the OS is booted after video memory setting is performed in accordance with the OS installed on the personal computer 100.

Referring to an exemplary flowchart of FIG. 4, a more detailed description is given of a method of setting video memory. The video memory setting is performed after selecting the table (A or B) corresponding to the OS (OS#1 or OS#2) installed on the personal computer 100 (block S306 or S308 in FIG. 3), and before booting the OS (block S310)

The BIOS detects the capacity of the system memory 112 of the personal computer 100 (block S400). For example, the BIOS can detect the capacity of the system memory 112 by obtaining specification information in an SPD (Serial Presence Detect) provided on the system memory 112. The SPD is a kind of ROM chip, and stores the specification information of the system memory 112 such as the memory size, the maximum clock frequency, the signal timing, etc.

The BIOS obtains, from the table (A or B) selected in block S306 or S308 shown in FIG. 3, a capacity of the video memory corresponding to the detected capacity of the system memory 112 (block S402). The BIOS sets the obtained capacity of the video memory as the capacity of the video memory of the personal computer 100 (block S404). More specifically, among the storage area of the system memory 112, an area corresponding to the obtained capacity of the video memory is allocated to the video memory (VRAM) 115. Accordingly, the remaining storage area of the system memory 112 serves as an actual system memory area. In this manner, the system memory and the video memory are set in accordance with the OS installed on the personal computer 100.

In the above description, the case is assumed where the personal computer 100 supports the two kinds of OSs. However, the number of OSs supported by the personal computer 100 is not limited to two, and may be three or more. In this case, the personal computer 100 can handle three or more kinds of OSs by, for example, increasing the number of bits set to the EEPROM 201. For example, in the case where two bits are set to the EEPROM 201, the following four kinds of bit values are available: “00”; “01”; “10”; and “11”. Accordingly, the personal computer 100 can handle four kinds of OSs by allocating one of the bit values to each of the OSs.

According to the above-mentioned embodiment, it is possible to realize an information processing apparatus that can flexibly and easily perform video memory setting for each of a plurality of kinds of OSs. Additionally, even in the case where a plurality of kinds of video memory settings are used in a single information processing apparatus, it is unnecessary to prepare as many BIOSs as the plurality of kinds of video memory settings. That is, it is possible to handle a plurality of kinds of OSs by using a single BIOS. Accordingly, it is possible to reduce development processes and development resources, and to simplify maintenance/management.

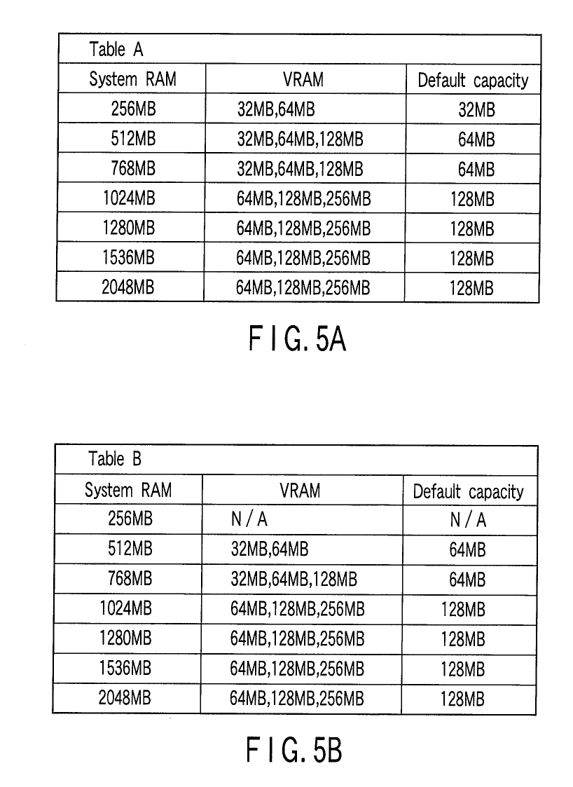

Referring to FIGS. 5A and 5B, a more detailed description is given of the above-mentioned tables A and B.

FIG. 5A is an exemplary table showing an example of the table A which stores the memory setting information corresponding to the OS#1. The table A stores combinations of: a capacity of system RAM (system memory); selectable capacities of video memory (VRAM); and the default capacity of the VRAM. For example, in the case where the capacity of the system RAM is 512 MB, a selectable capacity for the video memory is 32 MB, 64 MB, or 128 MB. However, in this case, since the default capacity is 64 MB, the capacity of the video memory initially set when the personal computer 100 is turned ON is 64 MB. As for the other capacities 32 MB and 128 MB, the user can set one of these values according to need after the personal computer 100 is turned ON. For example, the user can select 32 MB or 128 MB for the capacity of the video memory via, for example, a setup screen provided by the BIOS.

FIG. 5B is an exemplary table showing an example of the table B which stores the memory setting information corresponding to the OS#2. As in the above-mentioned table A, the table B also stores combinations of: a capacity of system RAM (system memory); selectable capacities of video memory (VRAM); and the default capacity of the VRAM. For example, in the case where the system RAM capacity is 512 MB, a selectable capacity for the video memory is 32 MB or 64 MB. However, in this case, since the default capacity is 64 MB, the capacity of the video memory initially set when the personal computer 100 is turned ON is 64 MB. However, after the personal computer 100 is turned ON, the user can set the capacity of the video memory 115 to 32 MB according to need via, for example, a setup screen provided by the BIOS.

In the case where the personal computer 100 supports three or more kinds of OSs using different memory settings, the video memory setting tables are prepared in accordance with the number of the supported OSs. In addition, those values stored in the table A shown in FIG. 5A and the table B shown in FIG. 5B merely serve as exemplary values, and other values may be stored in the tables A and B.

When the video memory setting is performed in the personal computer 100 as mentioned above, the OS obtains from the BIOS the memory setting information, such as the size of system memory, the size of video memory, the address range of the storage area allocated to the video memory, etc. The OS may obtain the memory setting information from the BIOS via, for example, WMI (Windows Management Instrumentation).

Generally, when the personal computer 100 is turned ON, the BIOS is executed, and then the OS is booted. Hence, the OS installed on the personal computer 100 is not directly confirmed at the time of activation of the BIOS. However, when shutting down the personal computer 100, by storing in the EEPROM 201 the identification information of the OS which is being executed, it is possible to automatically change the video memory setting when the personal computer 100 is turned ON the next time. For example, in the case where the user newly installs Windows Vista on the personal computer 100 on which Windows XP is already installed, when the personal computer 100 is turned ON the next time, the video memory setting can be changed to the setting corresponding to Windows Vista. A detailed description of this method is given below.

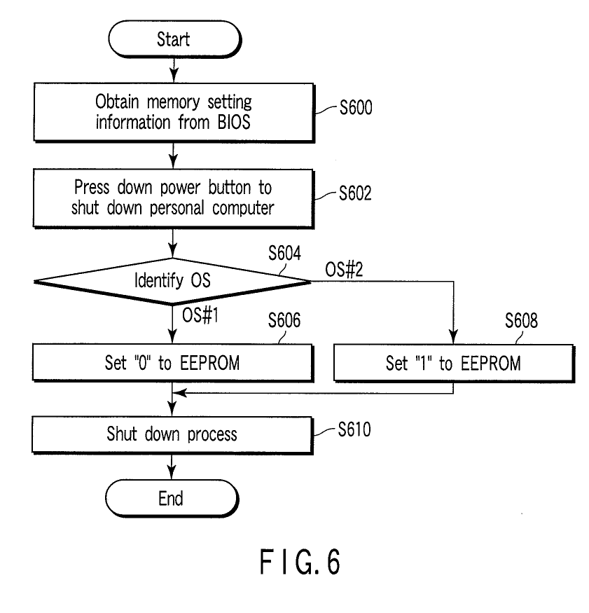

Referring to an exemplary flowchart of FIG. 6, a description is given of a method of automatically changing the video memory setting. As in the flowchart of FIG. 3, the flowchart of FIG. 6 shows an exemplary case where the personal computer 100 supports the two kinds of OSs (OS#1 and OS#2) using the different video memory settings.

After the OS is booted in the personal computer 100, the OS obtains memory setting information from the BIOS (block S600). In accordance with the obtained memory setting information, the OS accesses each of the system memory system memory 112 and the video memory 115. When the user ends using the personal computer 100, the user shuts down the personal computer 100 by, for example, pressing down the power button 21 (block S602). On this occasion, the OS sets the identification information for identifying the OS installed in the personal computer 100 to, for example, the EEPROM 201 (blocks S604, S606, and S608). Alternatively, the OS may set the identification information to, for example, the EEPROM 201 via the BIOS.

When the OS is the OS#1, “0”, for example, is set to the EEPROM 201 (block S606). On the other hand, when the OS is the OS#2, “1”, for example, is set to the EEPROM 201 (block S608). After the identification information of the OS installed in the personal computer 100 is set to the EEPROM 201 as mentioned above, a shut down process of the personal computer 100 is performed (block S610).

Accordingly, when the personal computer 100 is turned ON after the identification information of the OS is set to the EEPROM 201 as mentioned above, the BIOS obtains the set identification information to identify the OS, and selects a memory setting table corresponding to the OS to perform video memory setting (see FIGS. 3 and 4).

As mentioned above, by storing in the EEPROM 201 the information of the OS installed at the time when shutting down the personal computer 100, it is possible to automatically change the video memory setting in accordance with the OS when the personal computer 100 is turned ON the next time.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus, comprising:
a system memory;
a video memory allocated to a part of a storage area of the system memory;
a storing unit configured to store a plurality of tables each corresponding to one of a plurality of kinds of operating systems and storing a combination of a capacity of the system memory and a capacity of the video memory;
an identifying unit configured to identify an installed operating system;
a selecting unit configured to select, from the tables stored in the storing unit, a table corresponding to the installed operating system identified by the identifying unit;
a detecting unit configured to detect the capacity of the system memory; and
a setting unit configured to set the capacity of the video memory in accordance with the capacity of the system memory detected by the detecting unit and the table selected by the selecting unit.

2. The information processing apparatus according to claim 1, wherein the identifying unit is configured to identify the installed operation system based on a bit which is set to a non-volatile memory of the information processing apparatus.

3. The information processing apparatus according to claim 1, wherein the identifying unit is configured to identify the installed operating system based on a hardware identification which is set to a motherboard.

4. The information processing apparatus according to claim 1, wherein each of the tables store a combination of the capacity of the system memory, a default capacity of the video memory, and a selectable capacity of the video memory.

5. The information processing apparatus according to claim 4, wherein the default capacity of the video memory is a capacity which is initially set when the apparatus is turned on.

6. The information processing apparatus according to claim 4, wherein the selectable capacity of the video memory is a capacity which can be selected by a user after the apparatus is turned on.

7. An information processing method for an information processing apparatus in which a part of a storage area of a system memory is allocated to a video memory, the information processing method comprising:
identifying an installed operating system;
selecting a table corresponding to the identified operating system from a plurality of tables each corresponding to one of a plurality of kinds of operating systems, and storing a combination of a capacity of the system memory and a capacity of the video memory;
detecting the capacity of the system memory; and
setting the capacity of the video memory in accordance with the detected capacity of the system memory and the selected table.

8. The information processing method according to claim 7, wherein identifying the installed operating system comprises identifying the installed operating system based on a bit which is set to a non-volatile memory of the information processing apparatus.

9. The information processing method according to claim 7, wherein identifying the installed operating system comprises identifying the operating system installed on the information processing apparatus based on a hardware ID which is set to a motherboard.

10. The information processing method according to claim 7, further comprising:
setting, to a non-volatile memory, identification information for identifying the operating system when shutting down the operating system that is executed by the information processing apparatus,
wherein identifying the installed operating system comprises obtaining the identification information set to the non-volatile memory when the information processing apparatus is turned on.
